(19) United States
(12) Patent Application Publication
(10) Pub. No.: US 2022/0231762 A1
(43) Pub. Date: Jul. 21, 2022

(54) INTELLIGENT LIGHTING DEVICE AND A METHOD FOR SWITCHING SUCH A LIGHTING DEVICE

(71) Applicant: ELLIPZ SMART SOLUTIONS EUROPE, Paris (FR)

(72) Inventors: Jean-Baptiste SEILLIERE, CHAMBESY (CH); Suat TOPSU, VERSAILLES (FR)

(21) Appl. No.: 17/609,146

(22) PCT Filed: May 5, 2020
(86) PCT No.: PCT/FR2020/000162

§ 371 Date: Nov. 5, 2021

(30) Foreign Application Priority Data
May 5, 2019 (FR) 1904701

(51) Int. Cl. H04B 10/116; H05B 47/17; H05B 47/11; H05B 45/10; H05B 47/16

(52) U.S. Cl. CPC H04B 10/116; H05B 47/17; H05B 47/16; H05B 45/10; H05B 47/11

(57) ABSTRACT

In brief, the invention relates to a switching method (10) for switching a smart lighting device (100), the switching method (10) comprising a step of selecting an operating mode (130) of the lighting device (100) in such a way as to control the emission of a light signal (115) and/or a communication signal (125). Thus, advantageously, the light source (110) of the lighting device (100) thus controlled by the switching method (10) can emit the light signal (115) without emitting a communication signal (125), or the secondary source (120) can, alternatively or simultaneously to the operation of the light source (110), emit the communication signal (125). The switching method (10) thus offers a greater degree of modularity in the control of the lighting device (100). The invention also relates to a lighting device (100) controlled by such a switching method (10).

### TECHNICAL FIELD

The technical context of the present invention is that of communication by light in order to transport digital data by means of modulated electromagnetic radiation. More specifically, the invention relates to a smart lighting device and to a method for switching such a lighting device.

### PRIOR ART

In the prior art, light communication systems are known, such as those which implement LiFi (“Light Fidelity”) technology, which allows digital data to be transmitted wirelessly by simultaneously modulating the light emitted by LED (Light Emitting Diode) lights. LiFi technology is described in particular in the international standard IEEE802.15.

In particular, LIFI lighting systems are known which take the form of ceiling lamps or desk lamps in order to provide lighting, with light that is visible to the human eye, while simultaneously providing a communication signal by modulating the light intensity of the light emitted by such lighting systems.

In particular, document EP 3476185 B1 is known, which describes a set of interconnected ceiling lamps, each ceiling lamp comprising a plurality of visible light sources that are controlled by a controller configured to selectively control each light source of a given ceiling lamp. In particular, the controller makes it possible to turn on, turn off, or modulate lighting produced by each light source.

A known drawback is that these LIFI lighting systems must be on in order to provide wireless communication. In other words, these known lighting systems do not yet make it possible to combine the lighting function with that of communication, leaving the choice of desired functionality to the consumer. At present, such LIFI lighting systems intended for lighting do not make it possible to provide wireless communication without lighting.

Such LIFI lighting systems are then perceived by users as consumers of electrical energy and they do not allow this technology to be easily rolled out to the general public, who are reluctant to leave a light on in the middle of the day in order to have access to a wireless communication system.

An aim of the invention is to provide a new method of switching a smart lighting device as well as a new smart lighting device in order to address the above-described problems at least to a large extent and also to produce other advantages.

Another aim of the invention is to make it possible to offer a higher degree of modularity in the provision of lighting and wireless communication in order to better meet the needs of users.

Another aim of the invention is to enable LIFI to fulfill its promise of optimizing household energy consumption.

### DISCLOSURE OF THE INVENTION

According to a first aspect of the invention, at least one of the aforementioned objectives is achieved by means of a switching method for switching a lighting device comprising a light source, which is configured to be able to emit visible radiation in the form of a light signal and/or a communication signal, and a secondary source, which is configured to be able to emit the communication signal, the switching method making it possible to control the lighting device by selecting one of the following operating modes:
a first operating mode, referred to as the off state, in which the light source of the lighting device is configured not to emit the light signal and in which the secondary source of the lighting device is configured not to emit the communication signal;
a second operating mode, referred to as the simple lighting state, in which the light source of the lighting device is configured to generate the light signal and the secondary source of the lighting device is configured not to emit the communication signal;
a third operating mode, referred to as the smart lighting state, in which the light source of the lighting device is configured to simultaneously generate the light signal and the communication signal;
a fourth operating mode, referred to as the simple communication state, in which the light source of the lighting device is configured not to emit the light signal and the secondary source is configured to generate the communication signal.

Therefore, the switching method makes it possible to adapt an operating state of a lighting device by independently selecting emission of the light signal in order to produce illumination and/or emission of the communication signal in order to make it possible to transport digital data wirelessly. The switching method according to the first aspect of the invention thus makes it possible to offer a higher degree of modularity in the control of these lighting devices, and in particular smart lighting devices that make it possible to perform functions other than simple lighting by means of their light sources.

The switching method according to the first aspect of the invention advantageously comprises at least one of the improvements below, it being possible to take the technical features constituting these improvements alone or in combination:
The switching method according to the first aspect of the invention comprises a step of measuring an ambient brightness at the lighting device, the operating mode of the lighting device being set depending on the measured ambient brightness. The ambient brightness can be measured by any known photodetector, such as a photodiode;
The switching method according to the first aspect of the invention comprises a step of comparing the ambient brightness with a threshold value: if the ambient brightness is greater than the threshold value, the lighting device is switched into its fourth operating mode. In this advantageous embodiment, when the ambient brightness reaches the threshold value, the lighting device is controlled such that the communication signal is not provided by the light signal. Preferably, the communication signal is an infrared signal so as not to be visible to the human eye, and the secondary source is an infrared source;
In broader terms, the switching method according to the first aspect of the invention comprises a step of measuring an environmental parameter, the operating mode of the lighting device being set depending on the measured environmental parameter. By way of non-limiting example, the environmental parameter may be a chemical compound using an optical sensor or a chemical detector, a presence detector in order to detect a movement with a view to controlling the lighting device, a humidity level using a humidity sensor, etc.
The switching method according to the first aspect of the invention comprises a step of determining a time of day, the operating mode of the lighting device being set depending on the determined time of day. By way of non-limiting example, the time of day is determined by a clock integrated in the lighting device or by the transmission of information relating to the time of day to the lighting device, the step of determining the time of day comprising a step of receiving such information relating to the time of day, for example a universal time or an elapsed time;
The switching method according to the first aspect of the invention comprises a fifth operating mode, referred to as the ultra-communication state, in which the light source of the lighting device is configured to simultaneously generate the light signal and a first communication signal, and the secondary source of the lighting device is configured to generate a second communication signal. This advantageous embodiment thus makes it possible to increase the communication rates by offering two communication signals in parallel with one another.

According to a second aspect of the invention, a lighting device comprising means configured to implement the switching method according to the first aspect of the invention or according to any of the improvements thereto is provided.

A lighting device of this kind thus makes it possible to provide a higher degree modularity for the lighting and wireless communication functions.

In particular, the means of the lighting device according to the second aspect of the invention comprise (i) a light source, which is configured to generate first electromagnetic radiation, (ii) a secondary source, which is configured to generate radiation second electromagnetic radiation, and (iii) a control module, which makes it possible to control the light source and the secondary source in order to generate the first and the second electromagnetic radiation simultaneously or one at a time.

In broad terms, the first electromagnetic radiation allows for illumination and/or wireless communication, and the second electromagnetic radiation allows for wireless communication.

Advantageously, it is the control module of the lighting device according to the second aspect of the invention which is configured to implement the switching method according to the first aspect of the invention or according to any of the improvements thereto.

The lighting device according to the second aspect of the invention advantageously comprises at least one of the improvements below, it being possible to take the technical features constituting these improvements alone or in combination:
A wavelength of the second electromagnetic radiation generated by the secondary source is greater than 750 nm or less than 350 nm. This advantageous embodiment makes it possible to ensure that the second electromagnetic radiation is not perceptible to the human eye. Preferably, the secondary source is an infrared source, the wavelength of the second electromagnetic radiation being between 700 nm and 100 μm. This advantageous embodiment makes it possible to prevent the second electromagnetic radiation from being harmful to human vision;
The light source is configured to emit the first electromagnetic radiation, a wavelength of which is between 350 nm and 750 nm. This advantageous embodiment makes it possible to make the first electromagnetic radiation visible to the human eye;
Advantageously, the light source is a light-emitting diode source;
The lighting device according to the second aspect of the invention comprises a clock, which is configured to determine a time of day, the control module being configured to control the light source and/or the secondary source depending on the detected time of day. Depending on the time of day, the control module is configured to adapt a luminous flux and/or a lighting temperature. By way of non-limiting example, the luminous flux associated with the first magnetic radiation produced by the lighting device according to the second aspect of the invention may be zero during the day if the room in which the lighting device is installed is subjected to natural daytime lighting, while the luminous flux associated with the first magnetic radiation of said lighting device may be non-zero during the night in order to compensate for the drop in natural light. Additionally or alternatively, the lighting temperature may take a first value during the day in order to reproduce a natural lighting color, such as that which can be found outside for example, while the lighting temperature may take a second value that is warmer than the first value during the night in order to reduce eye fatigue. These advantageous embodiments of the control module are alternatives or complementary to the production of a communication signal by the lighting device according to the second aspect of the invention;
The lighting device according to the second aspect of the invention comprises a detector of an ambient brightness, the control module being configured to control the light source and/or the secondary source depending on the time of the detected ambient brightness. Advantageously, the brightness detector of the lighting device according to the second aspect of the invention is a photoreceiver, for example a photodiode or a CCD sensor;
By way of non-limiting examples, the lighting device according to the second aspect of the invention or according to any of the improvements thereto is chosen from a ceiling lamp, a desk lamp, or an outdoor floor lamp.

Various embodiments of the invention are provided, incorporating, in all of their possible combinations, the various optional features set out herein.

### DESCRIPTION OF THE FIGURES

Other features and advantages of the invention will become apparent from the following description and from various embodiments given by way of illustration and non-limiting example with reference to the appended schematic drawings, in which:

FIG. 1 is a block diagram of the various steps of the switching method according to the first aspect of the invention;

FIG. 2 is a schematic view of the lighting device according to the second aspect of the invention.

Of course, the features, variants and different embodiments of the invention can be associated with one another, in various combinations, insofar as they are not incompatible or mutually exclusive. It is in particular possible to envisage variants of the invention comprising only a selection of features described below in isolation from the other features described if this selection of features is sufficient to confer a technical advantage or to differentiate the invention from the prior art.

In particular, all the variants and all the embodiments described can be combined with one another if there is nothing to prevent this combination from a technical point of view.

In the figures, the elements common to multiple figures have the same reference sign.

### DETAILED DESCRIPTION OF THE INVENTION

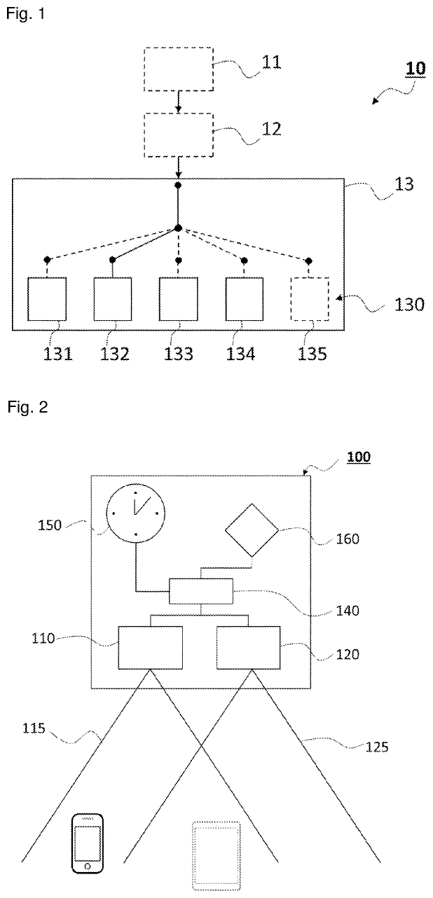

With reference to FIG. 1, the switching method 10 according to the first aspect of the invention is described below. A switching method 10 of this kind comprises a switching step 13 in an operating mode 130 chosen from among multiple operating modes of a lighting device 100 not shown in FIG. 1. The choice of one of the operating modes 130 makes it possible to operate the lighting device 100 according to a particular mode that depends on the selected switching state.

The lighting device 100 will be described in more detail with reference to FIG. 2. In broad terms, the lighting device 100 shown in FIG. 2 comprises a light source 110, which is configured to be able to emit visible electromagnetic radiation in the form of a light signal 115 and/or a communication signal, and a secondary source 120, which is configured to be able to emit invisible electromagnetic radiation in the form of the communication signal 125.

Thus, the communication signal 125 can be emitted either by the light source 110, or by the secondary source 120, or simultaneously by both the light source 110 and the secondary source 120. In the latter case, the lighting device 100 advantageously emits (i) a first communication signal 125a via the light source 110 and (ii) a second communication signal 125b via the secondary source 120.

Additionally or alternatively, the emission of the light signal 115 and/or of the control signal 125 is controlled by the switching method 10 according to the first aspect of the invention.

It is the switching method 10 according to the first aspect of the invention which makes it possible, in particular, to control the light source 110 and the secondary source 120 of the lighting device 100.

More specifically, the switching step 13 of the switching method 10 according to the first aspect of the invention makes it possible to control the lighting device 100 by selecting one of the following operating modes 130:
a first operating mode 131, referred to as the off state, in which the light source 110 of the lighting device 100 is configured not to emit the light signal 115 and in which the secondary source 120 of the lighting device 100 is configured not to emit the communication signal 125. In other words, in this first operating mode 131, the light source 110 and the secondary source 120 are simultaneously turned off;
a second operating mode 132, referred to as the simple lighting state, in which the light source 110 of the lighting device 100 is configured to generate the light signal 115 and the secondary source 120 of the lighting device 100 is configured not to emit the communication signal 125. In other words, in this second operating mode 132, only the secondary source 120 is turned off;
a third operating mode 133, referred to as the smart lighting state, in which the light source 110 of the lighting device 100 is configured to simultaneously generate the light signal 115 and the communication signal 125. In this third operating mode 133, the secondary source 120 may be configured to generate the communication signal 125 or it may be turned off;
a fourth operating mode 134, referred to as the simple communication state, in which the light source 110 of the lighting device 100 is configured not to emit the light signal 115 and the secondary source 120 is configured to generate the communication signal 125; and possibly
a fifth operating mode 135, referred to as the ultra-communication state, in which the light source 110 of the lighting device 100 is configured to simultaneously generate the light signal 115 and a first communication signal 125a, and the secondary source 120 of the lighting device 100 is configured to generate a second communication signal 125b.

In FIG. 1, the fifth operating mode 135, which is optional in the switching method 10 according to the first aspect of the invention, is shown in dashed lines. In addition, the different operating modes 130 of the lighting device 100 are shown in dashed lines, except the one selected by the switching method 10, in this case the second operating mode 132 in FIG. 1.

Additionally or alternatively, the switching method 10 according to the first aspect of the invention advantageously comprises a step of comparing 11 the ambient brightness with a threshold value. During this comparison step 11, if the detected ambient brightness is greater than the threshold value, the lighting device 100 is switched to its fourth operating mode 134. The ambient brightness is advantageously determined by a photometric measurement using a photosensitive sensor such as a photodiode. In this case, the photosensitive sensor is preferably integrated in the lighting device 100. Optionally, the ambient brightness may also be determined by transmitting an ambient brightness measured by a photosensitive sensor that is not part of the lighting device 100. In this case, the photosensitive sensor is externalized and located in a position other than that in which the lighting device 100 is installed. The transmission of the measured ambient brightness is advantageously carried out by means of wireless communication, for example by means of RFID, Bluetooth or LIFI, or by means of wired communication, for example by means of RS232 or Ethernet.

Additionally or alternatively, the switching method 10 according to the first aspect of the invention advantageously comprises a step of determining 12 a time of day, the operating mode 130 of the lighting device 100 being set depending on the determined time of day. According to a first alternative embodiment, the time of day is advantageously determined by a clock integrated in the lighting device 100. According to a second alternative embodiment, the time of day or a control instruction that depends on the time of day determined beforehand is transmitted to the lighting device 100. In this case, the clock is externalized and located in a position other than that in which the lighting device 100 is installed. The transmission of the time of day or of the corresponding control instruction is advantageously carried out by means of wireless communication, for example by means of RFID, Bluetooth or LIFI, or by means of wired communication, for example by means of RS232 or Ethernet.

FIG. 2 illustrates an embodiment of the lighting device 100 according to the second aspect of the invention and comprising means that are configured to implement the switching method 10 as described previously with reference to FIG. 1.

As mentioned above, the lighting device 100 comprises a light source 110, which is configured to be able to emit first visible electromagnetic radiation in the form of a light signal 115 and/or a communication signal 125, and a secondary source 120, which is configured to be able to emit second invisible electromagnetic radiation in the form of the communication signal 125.

More specifically, the means constituting the lighting device 100 comprise:
the light source 110, which is configured to generate the first electromagnetic radiation in the form of the light signal 115 and/or the communication signal 125. The light source 110 is advantageously of the type comprising one or more light-emitting diodes. According to a first alternative embodiment, the light-emitting diodes are a white light-emitting diode and/or a combination of green, red and blue light-emitting diodes. Alternatively or additionally, the light-emitting diodes are microdiodes. Advantageously, a wavelength of the first electromagnetic radiation generated by the light source is between 350 nm and 750 nm, such that the light signal 115 is visible to the human eye;
the secondary source 120, which is configured to generate the second electromagnetic radiation in the form of the communication signal 125. Preferably, the secondary source 120 is an infrared source that is configured such that the communication signal 125 formed by the second electromagnetic radiation has a wavelength greater than 750 nm or less than 350 nm, such that the communication signal 125 generated by the secondary source is not perceptible to the human eye and is not harmful to health;
a control module 140, which makes it possible to control the light source 110 and the secondary source 120 in order to generate the first and the second electromagnetic radiation simultaneously or one at a time. By way of non-limiting examples, the control module 140 in particular comprises a microprocessor and/or a microcontroller.

Within the context of the invention, the control module 140 is configured both to polarize the light source so as to emit a non-communicating light signal 115 and to generate a modulated control signal of the light source in order to generate a modulated light signal in the form of the light signal 115 and the communication signal 125 at the same time, depending on the operating mode 130 selected for controlling the lighting device 100.

In order to better control the light source 110 and/or the secondary source 120, the lighting device 100 according to the second aspect of the invention advantageously comprises:
a clock 150, which is configured to determine a time of day, the control module 140 being configured to control the light source 110 and/or the secondary source 120 depending on the time of day detected by the clock 150; and/or
a detector 160 of an ambient brightness, the control module 140 being configured to control the light source 110 and/or the secondary source 120 depending on the time of the ambient brightness detected by the detector 160.

In brief, the invention relates to a switching method 10 for switching a smart lighting device 100, the switching method 10 comprising a step of selecting an operating mode 130 of the lighting device 100 in such a way as to control the emission of a light signal 115 and/or a communication signal 125. Thus, advantageously, the light source 110 of the lighting device 100 thus controlled by the switching method 10 can emit the light signal 115 without emitting a communication signal 125, or the secondary source 120 can, alternatively or simultaneously to the operation of the light source 110, emit the communication signal 125. The switching method 10 thus offers a greater degree of modularity in the control of the lighting device 100.

The invention also relates to a lighting device 100 controlled by such a switching method 10.

Of course, the invention is not limited to the examples which have just been described and numerous modifications can be made to these examples without departing from the scope of the invention. In particular, the different features, forms, variants and embodiments of the invention can be associated with each other in various combinations insofar as they are not incompatible or mutually exclusive. In particular, all the variants and embodiments described above can be combined with one another.

1. Switching method for switching a lighting device comprising a light source, which is configured to be able to emit visible radiation in the form of a light signal and/or a communication signal, and a secondary source, which is configured to be able to emit the communication signal, the switching method making it possible to control the lighting device by selecting one of the following operating modes:
a first operating mode, referred to as the off state, in which the light source of the lighting device is configured not to emit the light signal and in which the secondary source of the lighting device is configured not to emit the communication signal;
a second operating mode, referred to as the simple lighting state, in which the light source of the lighting device is configured to generate the light signal and the secondary source of the lighting device is configured not to emit the communication signal;
a third operating mode, referred to as the smart lighting state, in which the light source of the lighting device is configured to simultaneously generate the light signal and the communication signal;
a fourth operating mode, referred to as the simple communication state, in which the light source of the lighting device is configured not to emit the light signal and the secondary source is configured to generate the communication signal;
characterized in that the secondary source is an infrared source of which the wavelength is between 700 nm and 100 μm.

2. Switching method according to claim 1, wherein the switching method comprises a step of measuring an ambient brightness at the lighting device, the operating mode of the lighting device being set depending on the measured ambient brightness.

3. Switching method according to claim 2, in which the switching method comprises a step of comparing the ambient brightness with a threshold value: if the ambient brightness is greater than the threshold value, the lighting device is switched into its fourth operating mode.

4. Switching method according to claim 1, wherein the switching method comprises a step of determining a time of day, the operating mode of the lighting device being set depending on the determined time of day.

5. Switching method according to claim 1, wherein the switching method comprises a fifth operating mode, referred to as the ultra-communication state, in which the light source of the lighting device is configured to simultaneously generate the light signal and a first communication signal, and the secondary source of the lighting device is configured to generate a second communication signal.

6. Lighting device comprising means that are configured to implement the switching method according to claim 1.

7. Lighting device according to claim 6, wherein the means comprise:
a light source, which is configured to generate first electromagnetic radiation having a wavelength between 350 nm and 750 nm;
a secondary source of the infrared type, which is configured to generate second electromagnetic radiation having a wavelength between 700 nm and 100 μm;
a control module, which makes it possible to control the light source and the secondary source in order to generate the first and the second electromagnetic radiation simultaneously or one at a time.

8. Lighting device according to claim 7, wherein the light source is a light-emitting diode source.

9. Lighting device according to claim 6, wherein the lighting device comprises a clock, which is configured to determine a time of day, the control module being configured to control the light source and/or the secondary source depending on the detected time of day.

10. Lighting device according to claim 6, wherein the lighting device comprises a detector of an ambient brightness, the control module being configured to control the light source and/or the secondary source depending on the time of the detected ambient brightness.
